(19) United States
(12) Patent Application Publication
(10) Pub. No.: US 2012/0075064 A1
(43) Pub. Date: Mar. 29, 2012

(54) PROXIMITY WAKE-UP ACTIVATION OF ELECTRONIC CIRCUITS

(75) Inventors: Duane W. BUCKINGHAM, Old Lyme, CT (US); Philipp A. ROOSLI, Niantic, CT (US)

(73) Assignee: INNCOM INTERNATIONAL, INC., NIANTIC, CT (US)

(21) Appl. No.: 12/955,054

(22) Filed: Nov. 29, 2010

Related U.S. Application Data
(63) Continuation of application No. 11/082,559, filed on Mar. 17, 2005, now abandoned.
(60) Provisional application No. 60/647,741, filed on Jan. 27, 2005.

(51) Int. Cl. G08B 29/00

(52) U.S. Cl. 340/5.64

(57) ABSTRACT

A lock system including a gateway device for generating a wireless activation signal and an electronic lock in communication with the gateway device, the electronic lock being activated in response to the activation signal whereby the electronic lock becomes operable.

### CROSS REFERENCE TO RELATED APPLICATIONS

This application is a continuation of U.S. patent application Ser. No. 11/082,559 filed on 17 Mar. 2005, which claims priority to U.S. Provisional Patent Application Ser. No. 60/647,741 filed on Jan. 27, 2005, both of which said applications are herein incorporated by reference in their entirety.

### BACKGROUND OF THE INVENTION

The present invention relates generally to selective activation of electronic circuits and, more particularly, to a system for selectively activating an electronic lock device of the type often found in hotels and other multi-unit buildings.

Multi-unit buildings such as hotels, motels, inns and the like are equipped with electronic lock devices installed in doors which provide a variety of functions including controlling access for security and safety purposes. Such lock devices often include certain access control electronics which read and attempt to verify a potential entrant's credentials and, if verified, signal a lock mechanism to unlatch the lock and thus allow entrance. Typical access control electronics include a reader for reading data from a magnetic stripe card, smart card, proximity card, etc., and further include circuitry required to verify such data and to signal the lock mechanism appropriately. The access control electronics are typically powered by a battery disposed in the door.

Increasingly, electronic locks in multi-unit buildings are being deployed as part of a central electronic lock control system (CELS). Such systems utilize a variety of means to communicate from a central server over a backbone to the individual door locks. Such means include hard-wiring, infrared and radio frequency (RF).

Generally, RF-based CELS systems, whether using magnetic stripe, smart or proximity access cards, have been made more economically feasible by the advent of RF mesh-net and similar technology. However, such RF-based systems do not operate in a “real time” mode of operation because of the excessive battery drain needed to keep the lock circuitry in an “active but sleeping” or “semi-comatose” mode (i.e., in a state which permits an external signal to awaken the lock so that it can transmit data and receive data and commands).

To overcome battery drain problems, RF-based CELS systems have adopted a periodic wake-up routine. This, for example, causes the lock to wake-up at periodic intervals (e.g., three minutes), at which time the lock transmits its “alive” status to the powered, centrally controlled part of the CELS backbone and, if there is message traffic, receives control-related data (e.g., a new lock access code) or transmits data toward the CELS server (e.g., audit trail data for entry events). For many applications, this solution is “adequate”, but it eliminates or reduces the effectiveness of certain important CELS features such as “remote room assignment transfer.” Importantly, it also reduces the inherent reliability of a true, on-line solution.

Further, where proximity cards are used in conjunction with electronic lock mechanisms, whether in a “standalone” or a CELS environment, the battery-powered electronic lock on the door needs to transmit a low-power RF “ping” signal every few seconds, so that when a guest with the correct proximity key card places the card near the lock, the card uses the RF energy from the “ping” signal and transmits its identification/access code back to the lock. If the access code is correct, then the access control electronics will unlatch the lock and permit access. The difficulty with battery-powered, proximity lock systems is that the periodic “ping” signals from the lock typically reduce battery life by fifty percent (50%) or more.

Similarly, in the case of magnetic stripe and smart card electronic lock mechanisms, maintaining the lock continuously in a active state can undesirably hasten battery depletion. Alternatively, maintaining the lock mechanism in a sleep or comatose state and periodically activating to connect the mechanism to the CELS backbone does not offer a true, on-line solution.

Therefore, an activation system for electronic circuits is desired that overcomes these disadvantages and provides extended battery life and a real-time solution for operation and communication. More specifically, an activation system for an electronic lock is desired which activates the lock only when operation thereof is necessary and which otherwise allows the lock mechanism to remain in an inactive state to thus conserve the mechanism's internal power source, but which still allows the lock to be available for activation any time as required or desired.

### SUMMARY OF THE INVENTION

The above-described deficiencies of the prior art are overcome or alleviated by an exemplary system which sets an electronic lock device to an inactive mode while the operation of the lock is not required and which, at any time, can activate the lock device when operation thereof or communication therewith is required. In one embodiment, a gateway device is in communication with a lock device wherein the lock corresponds to a unit of a multi-unit building. The lock device will remain in an inactive mode with no battery drain unless an event occurs or a condition is met, either locally at the lock itself or at the gateway device, that causes the lock to activate.

The above discussed and other features and advantages of the present invention will be appreciated and understood by those skilled in the art from the following detailed description and drawings.

### BRIEF DESCRIPTION OF THE DRAWINGS

Referring now to the drawings wherein like numerals designate like components:

FIG. 1 is a plan view of an exemplary room in a multi-room unit; and

FIG. 2 is a schematic block diagram of an electronic lock system of the invention.

### DETAILED DESCRIPTION OF THE PREFERRED EMBODIMENT

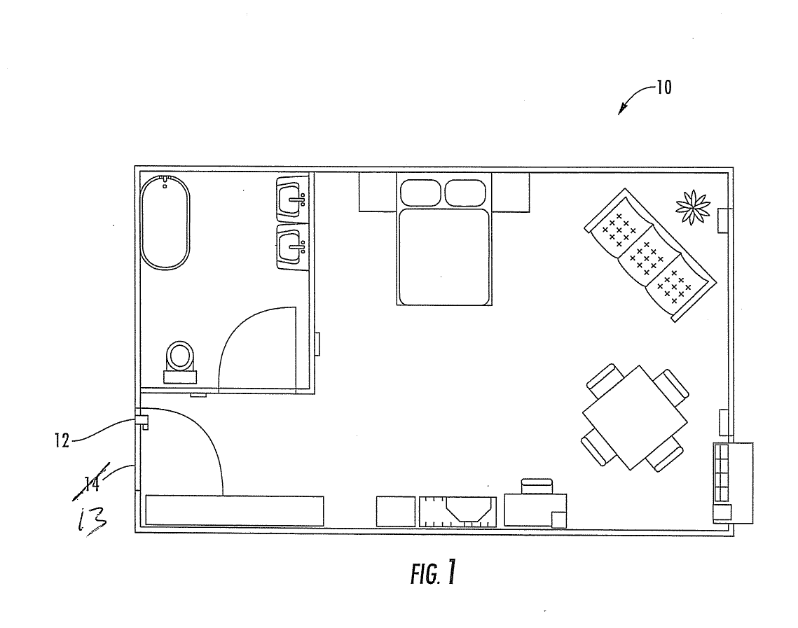

FIG. 1 shows an exemplary room 10 of a multi-unit building, the room including a number of devices for enhancing the security and convenience of occupants and the operating efficiency of the staff of the multi-unit building. One such device is a lock device 12 on a door 14 of the room. The multi-unit building may, for example, include a hotel, motel, inn, dormitory, cooperative, apartment, condominium, and the like, that offers a variety of services and facilities for the security and convenience of their guests or residents (occupants).

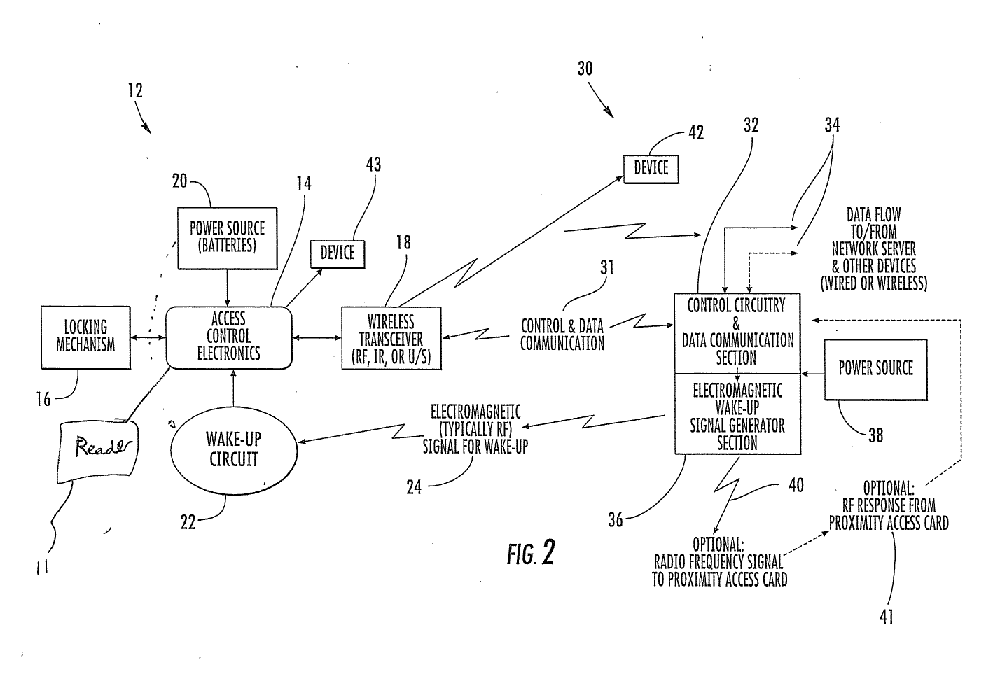

Referring to FIG. 2, the lock device 12 includes access control electronics 14 for controlling and operating a locking mechanism 16. The access control electronics 14 includes a microcontroller (not shown) having associated memory, i.e., random access memory (working memory) and non-volatile memory (boot-code and programming instructions) and an interface for providing data communication over a Local Area Network (LAN) or a Wide Area Network (WAN), as may be the case. The access control electronics 14 is capable of communicating over the network in any suitable protocol (e.g., TCP/IP, UDP/IP, WiFi, 802.15.4, ZigBee, Inncom International, Inc.'s proprietary P5 Protocol, etc.). The access control electronics 14 interfaces with the network by way of a wireless communication configuration comprising a wireless transceiver 18 connected to the micro controller of the access control electronics 14. The wireless transceiver 18 preferably communicates via radio frequency (RF) communication, but may alternatively and/or additionally utilize infrared (IR) or other types of communication (e.g., ultrasound (U/S), etc.). Wireless RF communication may utilize, for example, 802.11b radio frequency protocol, WI-FI, Bluetooth®, or any other suitable protocol. The access control electronics 14 are powered by a power source 20, as shown in FIG. 2. The power source 20 is preferably a battery (traditional or rechargeable) but may include any suitable power source including a storage capacitor, etc.

The micro controller of the access control electronics 14 is generally described herein as having integrated elements. However, it will be appreciated that the memory and interface could be discrete elements, as is well known in the art. Also, the micro controller may alternatively comprise a microprocessor, a programmable logic device (PLD), a programmable logic array (PLA), a programmable logic controller (PLC) or other suitable device, each being well known in the art and the configuration of each being readily apparent to one skilled in the art.

The lock device 12 of FIG. 2 further includes a wake-up circuit 22 which is arranged in communication with the access control electronics 14. As will be discussed further in detail, the wake-up circuit 22 is capable of receiving a designated wireless electromagnetic signal 24 and utilizing the signal to wake-up the access control electronics 14 and thus activate the lock device 12.

As will be discussed herein in further detail, the micro controller of the access control electronics 14, upon detection of transmitted data or instructions, or a request to transmit data, processes the data or request. In the case of a request for data, such as dates and times of entry into the room or the status of the lock or system itself, results of the processing are then transmitted via the transceiver 18 to the network or other peripherals of the system for further processing. Where instructions are sent, the control electronics 14 may actuate a mechanism in the lock to open or close the lock to correspondingly lock or unlock the door 14 or the electronics 14 may set the lock to active or inactive status. Where data is being sent, the micro controller may save identification or access information for future verification functions.

The system of the invention further includes a gateway device 30 employed within or immediately outside of the room 10 and preferably disposed proximate to the door 14 and lock device 12. The gateway device 30 includes a control circuitry and data communication section 32 (CCDCS) having a micro controller (not shown) with associated memory, i.e., random access memory (working memory) and non-volatile memory (boot-code and programming instructions) and an interface for providing data communication 34 wired or wirelessly with a network (LAN, WAN, etc.). The CCDCS 32 includes a wireless transceiver (not shown) connected to the micro controller for providing and receiving wireless (preferably RF) communication with respect to the transceiver 18 of the lock device 12.

The gateway device 30 further includes an electromagnetic wake-up signal generation section 36 which is arranged in communication with the CCDCS 32 and which is configured to selectively transmit the wireless electromagnetic wake-up signal 24 to the wake-up circuit 22 of the lock device, as will be discussed in further detail herein. The gateway device 30 is powered by a power source 38 which may provide necessary power by wired or wireless means. Preferably, the power source 38 is a wired source of continuous power which may also be used to provide power to other features and component of the room 10.

While the micro controller of the CCDCS 32 is described as having integrated elements, it will be appreciated that the memory and interface could be discrete elements, as is well known in the art. Also, the micro controller may alternatively comprise a microprocessor, a programmable logic device (PLD), a programmable logic array (PLA), a programmable logic controller (PLC) or other suitable device, each being well known in the art and the configuration of each being readily apparent to one skilled in the art.

The powered gateway device 30 is external to the lock device 12 and could be for example, disposed at or within an entry light switch, a doorbell, a do not disturb/make up room plate, an illuminated room number plate or any other device in proximity to the lock 12.

The gateway device 30 is capable of communicating over the network in any suitable protocol (e.g., TCP/IP, UDP/IP, WiFi, 802.15.4, ZigBee, Inncom International, Inc.'s proprietary P5 Protocol, etc.). The gateway device 30 interfaces with the network by way of conventional wired or wireless communication configurations in a suitable protocol. Also as mentioned, the gateway device 30 communicates with the lock device 12 via wireless communication in any suitable protocol. Preferable wireless communication includes electromagnetic signals such as radio frequency (RF) signals, for example, 802.11b radio frequency protocol, WI-FI, Bluetooth®, or any other suitable protocol.

As will now be discussed, in use, the system of the invention allows the lock device 12 to remain inactive until operation thereof is required, thus not drawing upon the battery 20 for operating power, while still providing an on-line, real-time system. In essence the lock is only activated in response to an access attempt by an occupant and in response to a wake-up signal sent by the signal generator 36. The wake-up signal 36 may be sent to activate the lock device 12 for data or command transfer or other communication from the gateway device 30 in order to conduct a system reliability check, to execute an emergency unlatch command, etc.

When operation is not required on the part of the lock device 12, it is set as inactive. In this mode, the access control electronics 14 draw minimal or no power from the battery 20.

Where the lock device 12 allows access via a magnetic stripe card or via a smart card, the access control electronics are awakened or activated by the potential occupant swiping or inserting the card into a reader (not shown) which forms a part of the access control electronics 14. That is, the control electronics 14 may include a switch of some known type which is triggered by swiping or inserting the card and which then activates the control electronics 14. The reader reads data stored in the card and attempts to verify such data. If verification is achieved, the control electronics 14 signal the locking mechanism 16 to unlatch and thus provide access. The verification of the card data may occur locally within the lock device 12 or, via the wireless transceiver 18, may utilize remote facilities of the gateway device 30 or the network.

In addition to such magnetic stripe/smart card local event activation, the lock device 12 may be selectively activated by the gateway device 30. As mentioned above, the wake-up signal generator section 36 of the gateway device 30 is configured to send the electromagnetic RF wake-up signal 24 to the wake-up circuit 22 of the lock device 12. The circuit 22 is an electromagnetic proximity type circuit which converts the wake-up signal 24 to electrical energy which is used to jolt the access control electronics 14 into an activated state. The gateway device 30 may send the wake-up signal 24 at any time as desired to selectively activate the lock device 12 in order to enable transfer of data, communications, commands, etc. for conducting a system reliability check, executing an emergency unlatch command, etc. Once the access control electronics 14 are activated, they draw upon the power source 20 for power. When operation of the lock device 12 is complete, the control electronics 14 return the lock 12 to the inactive state.

Where the lock device 12 allows access via a proximity card, the signal generator 36 of the gateway device 30 transmits an additional electromagnetic proximity signal 40 to be received by the proximity card. This proximity signal 40 (preferably an RF signal distinct from wake-up signal 24) may be an intermittent ping signal, as is common with proximity devices, or a continuous signal, as desired. When a potential entrant approaches the lock device 12, the proximity card is correspondingly brought sufficiently proximate to the gateway device 30 to receive the proximity signal 40. Upon receiving the signal 40, the proximity card is activated and transmits in return an identification signal 41 containing relevant data stored within the card. The CCDCS 32 of the gateway device 30 receives and verifies the identification signal 41 either locally within the device 30 or via the network connection 34. If the identification signal 41 is verified, the gateway device 30 commands transmission of the wake-up signal 24 which is received by the wake-up circuit 22 and which then initiates activation of the lock device 12. The gateway device 30 nearly simultaneously transmits a wireless unlock signal 31 to the wireless transceiver 18 instructing the access control electronics 14 to unlock (i.e. open) the locking mechanism 16 and thus grant access to the entrant. In an alternative arrangement, upon sensing the identification signal 41 transmitted by the proximity card, the gateway device 30 may simply activate the locking device 12 via the wake-up circuit 22. Then, verification of the identification data of the proximity card may be conducted by the lock device 12 in the manner discussed above with respect to the magnetic stripe/smart card system configuration.

In addition to such magnetic stripe card, smart card, and proximity card activation, the lock device 12 may be selectively activated by the gateway device 30 as desired. That is, at any time, the signal generator section 36 of the gateway device 30 may transmit the wake-up 24 signal in order to activate the lock device 12 and thus enable data or command transfer and/or communications via the wireless transceiver 18 for system reliability checks, etc.

The wireless transceiver 18 of the lock device 12 has thus far been described, by way of example, as being configured to wirelessly communicate and/or exchange data, etc. with the gateway device 30 and particularly with the CCDCS of the gateway 30. Additionally and/or alternatively, the wireless transceiver 18 may be disposed to communicate with a device 42 which is not a direct component of the gateway 30. Such device 42 may include, for example, a thermostat, a set-top box, a lighting control module, telephone/control console, or an auxiliary communication device. Further, the wireless transceiver 18 may be configured to interact wirelessly in a direct manner with the network, without interfacing with the gateway 30.

In another exemplary embodiment, the access control electronics 14 of the lock device 12 may be configured to communicate with a device 43 disposed, for example, in the lock device 12 or in the door 14 in which the lock device 12 is located. The device 43 may include, for example, a visual, auditory, or tactile signal device, a camera, a further communication device, etc. The access control electronics 14 may interact with the device 43 by any suitable wired or wireless arrangement. Where a wireless arrangement is employed, the access control electronics 14 may communicate with the device 43 via the wireless transceiver 18. The device 43 may be powered by the power source 20 of the lock device or may include its own source of power. The device 43 may be activated by the wake-up circuit 22 or by its own similar wake-up circuit arrangement. Of course, the invention contemplates various combinations and modifications of these and the additionally discussed exemplary embodiments.

The system results in the lock device 12 being maintained in a dormant, inactive state when operation of, or communication with, the lock device 12 is not required or necessitated. In such dormant, inactive state, the lock device 12 draws minimal or no power from the power source 20. The system only activates the lock device 12 upon occurrence of a predetermined triggering event (e.g., an access attempt by an occupant or a wake-up signal sent by the signal generator 36, as discussed). Only in this activated state does the lock device 12 draw significant power from the power source 20. Therefore, the power needs of the lock device 12 are substantially reduced while, at the same time, an on-line, real time system is provided for accessing and actuating the lock device.

It will be understood that the RF wireless communications utilized by the system can be transmitted and received by a hand held device such as a personal digital assistant (PDA), which supports RF communication. Such device may be advantageously carried by a staff member to enable the staff member to access and inspect the status of the lock or circuitry, or wake-up the lock on an as needed basis.

It is within the scope of the present invention that the micro controllers described herein can perform much of the described processing. That is, the micro controllers have sufficient processing power to accomplish the desired tasks. For example, the micro controllers may collect and process entry/access data for automated monitoring of the entry and exit into the room, as described hereinbefore. Further, from this data processing, the micro controllers may generate a report of entry and exit dates and times as well as the source of the activation. This report can be printed, displayed, and/or archived.

A log of the access data may be generated. This log would be useful for analyzing anomalies or flagging suspect activity with guests, at a later time. Further, the log could be useful to maintenance or security departments for monitoring the multi-unit building for possible system malfunction or security breaches. The log could be sent directly to a main security function, such as within the company/corporation or an outside vendor responsible for the building's security.

Access of the electronic lock system has been described herein by way of example as comprising identification card access techniques involving magnetic stripe cards, smart cards, and proximity cards. However, the electronic lock system of the invention is not limited to such card access configurations. For example, a potential entrant may attempt to access the electronic lock system by way of a key, a keypad, a touch pad or screen, or by way of biometric means such as a fingerprint scan, a retinal scan, etc., or any other known or conceivable access means or techniques.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A lock system comprising:
a gateway device disposed for generating a wireless activation signal; and
an electronic lock in communication with the gateway device, the electronic lock being activated in response to the activation signal whereby the electronic lock becomes operable.

2. The system of claim 1, wherein the activation signal comprises an electromagnetic emission and wherein the electronic lock comprises a wake-up circuit configured to receive the electromagnetic emission, to convert the electromagnetic emission to electrical energy, and to activate the electronic lock using the electrical energy.

3. The system of claim 1, wherein the gateway device comprises an activation signal generator for generating the wireless activation signal and wherein the electronic lock comprises a wake-up circuit for receiving the wireless activation signal and for converting the wireless activation signal into electrical energy used to activate the electronic lock.

4. The system of claim 2, further comprising:
an access device;
wherein the gateway device is said disposed for generating the wireless activation signal when at least one of the gateway device and the electronic lock verify user data read by the access device.

5. The system of claim 4, wherein the access device is configured to read the user data from an access card presented by a user to the access device.

6. The system of claim 1, wherein the electronic lock includes a power source which provides operating power to the electronic lock only when the lock is operable.

7. The system of claim 1, wherein the electronic lock is disposed is a door and the gateway device is disposed proximate to the door and wherein the electronic lock is configured to convert the activation signal into electrical power and to use said electrical power to activate the electronic lock and render the lock operable.

8. The system of claim 8, wherein the gateway device is in communication with a network of a multi-unit building, the gateway device being capable of transmitting data to and receiving data from the network and selectively communicating the data to the lock.

9. The system of claim 1, wherein the electronic lock is configured to wirelessly communicate with the gateway device when the lock is operable.

10. The system of claim 1, wherein the gateway device is further disposed for generating a proximity signal to be received by a proximity card.

11. The system of claim 12, wherein the proximity card is disposed for generating an identification signal in response to the proximity signal, wherein the gateway device attempts to verify the identification data, and wherein, upon verification of the identification data, the activation signal is generated and the lock opens.

12. The system of claim 1, wherein at least one of the electronic lock and the gateway device is disposed to validate credentials of a potential entrant and to open the lock when said credentials are validated.

13. The system of claim 1, wherein the lock is disposed, when operable, for actuating a locking mechanism, communicating wirelessly with the gateway device, and receiving power from an internal power source.

14. The system of claim 1, wherein the electronic lock is configured for wireless communication with at least one of a network and a room device.

15. An electronic lock, comprising:
an access device; and
a wake-up circuit;
wherein the electronic lock is activated in response to at least one of an access attempt at the access device and a wireless activation signal received by the wake-up circuit, whereby the electronic lock becomes operable.

16. The electronic lock of claim 17, further comprising a power source which provides operating power to the electronic lock only when the lock is operable.

17. The electronic lock of claim 17, further comprising a gateway device including an activation signal generator for generating the wireless activation signal and wherein the wake-up circuit is disposed for receiving the wireless activation signal and for converting the wireless activation signal into electrical energy used to activate the electronic lock.

18. The electronic lock of claim 19, wherein the access device emits an electromagnetic proximity signal, wherein the access attempt comprises a user placing a proximity device proximate to the access device.

19. The system of claim 17, wherein the electronic lock is configured for wireless communication with at least one of a network and a room device.

20. A method of operating an electronic lock, the method comprising:
placing the electronic lock in an inactive state in which operating power is not supplied to the electronic lock;
activating the electronic lock in response to at least one of a wireless activation signal and an access attempt, whereby the electronic lock becomes operable and whereby operating power is provided to the electronic lock.
